(19) United States
(12) Patent Application Publication
(10) Pub. No.: US 2010/0200565 A1
(43) Pub. Date: Aug. 12, 2010

(54) CONTROL SYSTEM FOR ELECTRIC HEATING ELEMENTS

(76) Inventors: Tony W. Leung, Hampton, VA (US); Daniel Joseph Trice, Louisville, KY (US); Michael Thomas Chezem, Georgetown, IN (US); Brian Michael Schork, Louisville, KY (US); Jason Northcut, Louisville, KY (US)

Correspondence Address: General Electric Company;GE Global Patent Operation, 2 Corporate Drive, Suite 648, Shelton, CT, 06484, US

(21) Appl. No.: 12/366,788

(22) Filed: Feb. 6, 2009

(51) Int. Cl. H05B 3/68; H05B 3/02

(52) U.S. Cl. 219/443.1; 219/483

(57) ABSTRACT

A cooking appliance including two or more independently controllable heating elements disposed on a cooktop of the cooking appliance; and a control circuit including two or more switches and configured to be operative in a first mode to enable each switch to independently control a respective one of the two or more independently controllable heating elements, and operative in a second mode to disable independent control of the two or more independently controllable heating elements, and enable one of the switches to simultaneously control the respective ones of the two or more independently controllable heating elements as a single unit.

### BACKGROUND OF THE INVENTION

The exemplary embodiments of the present invention generally relate to cooking appliances. More particularly, the exemplary embodiments relate to a control arrangement that enables simultaneous control of two or more heating elements of a cooking appliance.

Griddles for cooking appliances such as stoves and cooktops may be placed over multiple heating elements of the cooking appliance. Generally users of the griddles independently adjust each of the multiple heating elements in an attempt to balance out the heat applied to the griddle by the heating elements. Detection of the heat distribution across the griddle is generally performed through some sensory feedback, such as visual heat indications (e.g. charring, boiling, smoking, etc. of the items being cooked). Adjustments to the individual heating elements may be made continually based on the user's sensory feedback. Achieving a uniform heat distribution across the griddle is generally difficult to achieve and/or detect through the independent adjustment of the heating elements.

### BRIEF DESCRIPTION OF THE INVENTION

As described herein, the exemplary embodiments overcome one or more of the above or other disadvantages known in the art.

One aspect of the exemplary embodiments relates to a cooking appliance. The cooking appliance includes two or more independently controllable heating elements disposed on a cooktop of the cooking appliance; and a control circuit comprising two or more switches and configured to be operative in a first mode to enable each switch to independently control a respective one of the two or more independently controllable heating elements, and operative in a second mode to disable independent control of the two or more independently controllable heating elements, and enable one of the switches to simultaneously control the respective ones of the two or more independently controllable heating elements as a single unit.

Another aspect of the exemplary embodiments relates to a control system for electric heating elements of a cooking appliance. The control system includes two or more switches configured to independently control respective heating elements disposed in a griddle zone. The two or more switches are further configured to be operative in a griddle mode to simultaneously control the heating elements disposed in the griddle zone as a single unit.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and that, unless otherwise indicated, they are merely intended to conceptually illustrate the structures and procedures described herein. In addition, any suitable size, shape or type of elements or materials could be used.

### BRIEF DESCRIPTION OF THE DRAWINGS

In the drawings:

FIGS. 1 and 2 are a schematic illustrations of an exemplary appliance incorporating features of an exemplary embodiment;

FIG. 3 is a schematic illustration of a portion of an exemplary heating element control system of the appliance in FIGS. 1 and 2 in accordance with an exemplary embodiment;

FIGS. 4A and 4B are schematic illustrations of a portion of an exemplary heating element control system of the appliance in FIGS. 1 and 2 in accordance with an exemplary embodiment; and

FIGS. 5A-5D are schematic illustrations of an exemplary heating element control system of the appliance in FIGS. 1 and 2 in accordance with an exemplary embodiment.

### DETAILED DESCRIPTION OF THE EXEMPLARY EMBODIMENTS OF THE INVENTION

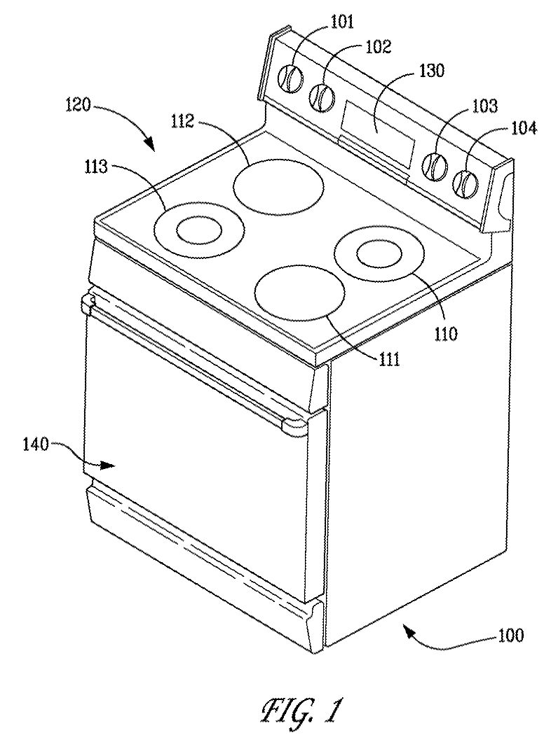

FIG. 1 illustrates an exemplary appliance 100 in accordance with an exemplary embodiment. In this example the appliance 100 is shown as a range but in alternate embodiments the appliance may be, for example, any suitable cooking appliance having individually operable surface heating elements including, but not limited to, cabinet mounted cooktops and portable grilling units. The appliance 100 includes a cooktop 120 having surface heating elements 110-113, an oven 140, control knobs 101-104 (and corresponding switches) and a display 130. The heating elements 110-113 may be any suitable heating elements such as, for example, single heating elements or multiple ring heating elements. In alternate embodiments the heating elements may have any suitable number of heating element rings for selecting a size of an active surface area of the heating element. The heating elements 110-113 may have any suitable heat rating. For example, the heating elements 110-113 may all have the same heat rating or one or more of the heating elements 110-113 may have a heat rating different from heat ratings of the other heating elements. The display 130 may be configured to present any suitable information related to the operation of the appliance 100 and/or allow operation of the oven 140.

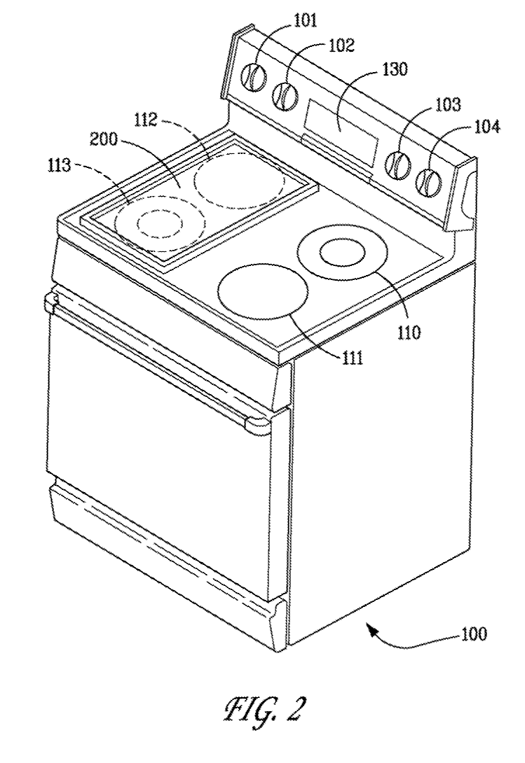

The exemplary embodiments provide for the simultaneous control of two or more heating elements as a unit (e.g. the two or more heating elements are effectively operated or controlled as a single heating element) using a single control. For example, referring to FIG. 2, a griddle 200 may be placed over heating elements 112, 113. Heating elements 112, 113 will be referred to herein as the first heating element 112 (e.g. left rear heating element) and the second heating element 113 (e.g. left front heating element) for exemplary purposes only. It should be realized that references made to the left, right, front and back are merely for exemplary purposes and ease of description. While each of the first and second heating elements 112, 113 may be individually operated through their respective control knobs 101, 102, providing a substantially uniform heat gradient across the griddle 200 may prove difficult through individual or separate control of the first and second heating elements 112, 113. In accordance with the exemplary embodiments, the controls for the first and second heating elements 112, 113 may be configured for selectively simultaneously controlling heating elements 112, 113 as a unit using a single control so that a substantially uniform heat gradient is easily applied across the cooking surface of the griddle 200.

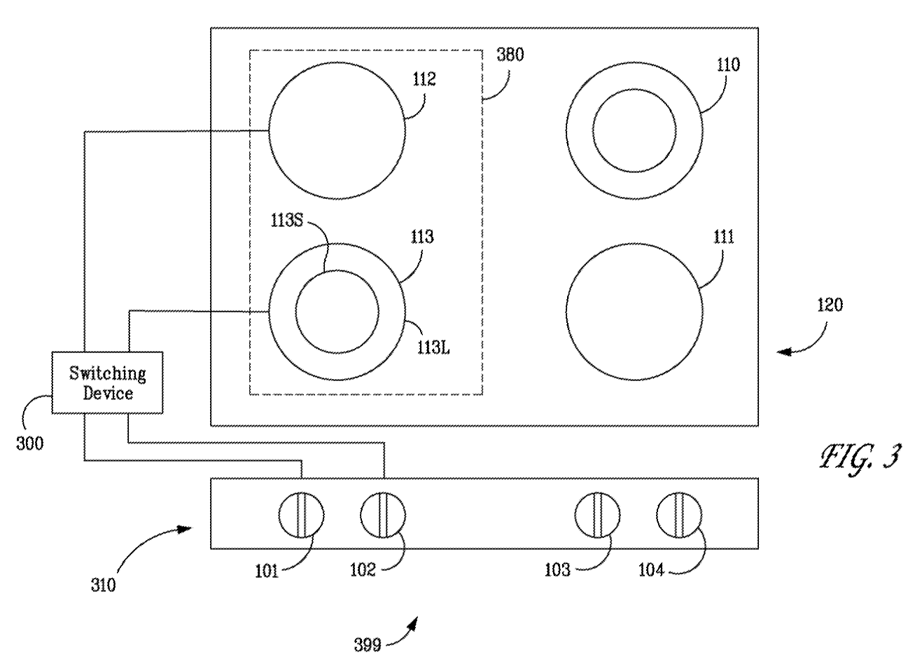

Referring now to FIG. 3, an exemplary heating element control system 399 is illustrated in accordance with an exemplary embodiment. It is noted that the heating element control system 399 shown is for exemplary purposes only and in alternate embodiments the heating element control system may include any suitable components or have any suitable configuration for simultaneously controlling two or more heating elements as a unit. In this example, two of the four heating elements may be simultaneously controlled as described below to form a griddle zone 380. In other examples, more than two heating elements may be simultaneously controlled to form a griddle zone having any suitable size and/or shape.

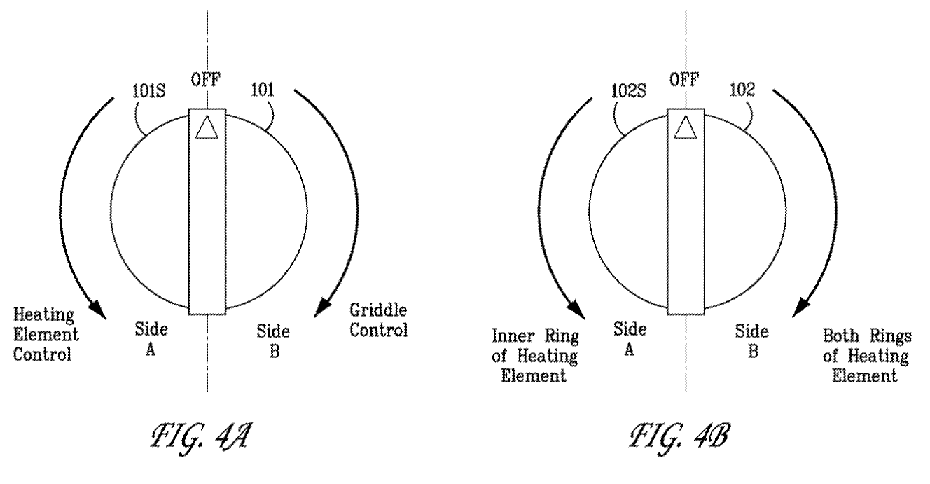

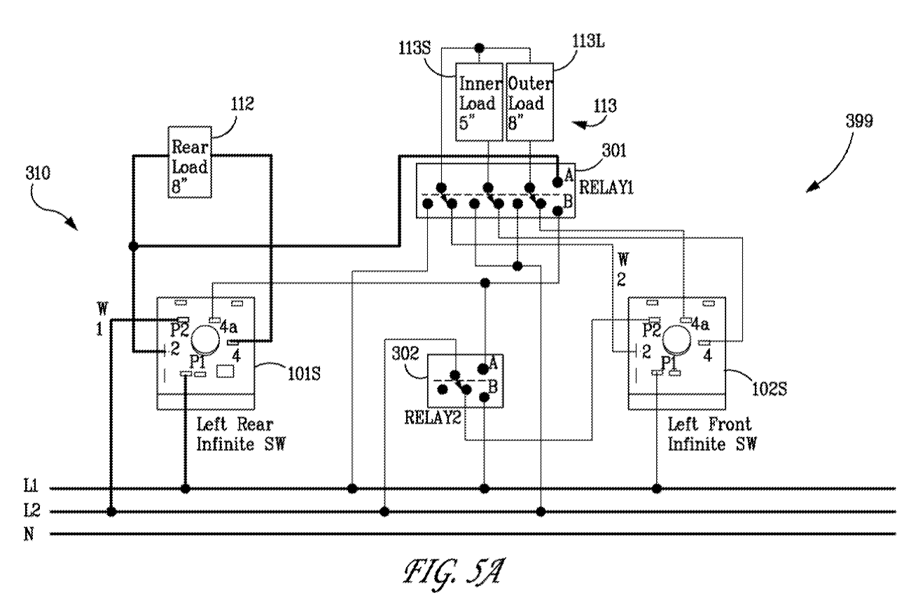

In accordance with an exemplary embodiment, the cooktop 120 includes the first and second heating elements 112, 113, a third heating element 110 (e.g. right rear heating element) and a fourth heating element 111 (e.g. right front heating element). The first and fourth heating elements 112, 111 are configured as single ring heating elements while the second and third heating elements 113, 110 are configured as multiple ring heating elements such as, for example, double ring heating elements. In alternate embodiments the heating elements may include any suitable types and/or combinations of heating elements having any suitable number of heating rings. Switches 101S-102S (FIGS. 4A and 4B) are provided for selectively operating the heating elements 112and 113. In this exemplary embodiment, the switches 101S-102S are infinitely variable rotary switches, such as infinite heat switches. In alternate embodiments the switches for operating the heating elements may be any suitable switches, including but not limited to, the infinitely variable switches, multiple position selector switches or any other switch having any suitable actuators (e.g. button, toggle, sliders, etc.). It is noted that while the exemplary embodiments are described herein with respect to the first and second heating elements 112, 113 and their respective controls, it should be understood that the controls for the third and fourth heating elements 110, 111 may be configured in a similar manner for selectively operating the third and fourth heating elements 110, 111 as a unit in a manner substantially similar to that described below with respect to the first and second heating elements 112, 113. Accordingly, an appliance in accordance with the exemplary embodiments may have any suitable number of griddle zones.

In the exemplary embodiment, referring to the second heating element 113 as an example, the dual ring heating elements may include an inner ring or element 113S and an outer ring or element 113L. The outer element 113L may substantially surround the inner element 113S to effectively enlarge an active surface area of the heating element. The dual ring heating elements may be selectively operated in, for example one of two heating modes. In a first heating mode only the inner element 113S is active to produce heat, while in a second heating mode both of the inner element 113S and outer element are active to produce heat thereby enlarging the active surface area of the heating element. Referring to FIGS. 3 and 4B, the dual ring heating elements are controlled through a control knob 102 of switch 102S. In alternate embodiments the dual ring heating elements may be controlled in any suitable manner. The switch 102S has two modes of operation for independently operating the second heating element 113. When the control knob 102 is rotated to a first side, referred to herein as Side A of the switch 102S, the inner element 113S of the dual ring second heating element 113 is activated independently of the outer element 113L and the other heating elements 110-112. When the control knob 102 of the switch 102S is rotated to a second side, referred to herein as Side B of the switch 102S, both of the inner element 113S and the outer element 113L are simultaneously activated independently of the other heating elements 110-112.

Referring to FIGS. 3 and 4A, the single ring heating element, referring to the first heating element 112, is controlled by switch 101S through control knob 101. In alternate embodiments the single ring heating elements may be controlled in any suitable manner. The switch 101S includes two modes of operation such that when the control knob 101 is rotated to Side A of the switch 101S, the first heating element 112 is activated independently of the other heating elements 110, 111, 113. When the control knob 101 is rotated to Side B of the switch 101S, both of the first and second heating elements 112, 113 of griddle zone 380 may be simultaneously activated (and the control, e.g., control knob 102 and switch 102S, normally used to control the heating element 113 is deactivated) so that the first and second heating elements 112, 113 are controlled as a unit. Simultaneous activation of the first and second heating elements 112, 113 as a unit by turning the control knob 101 to Side B of the switch 101S will be referred to herein as griddle mode or control.

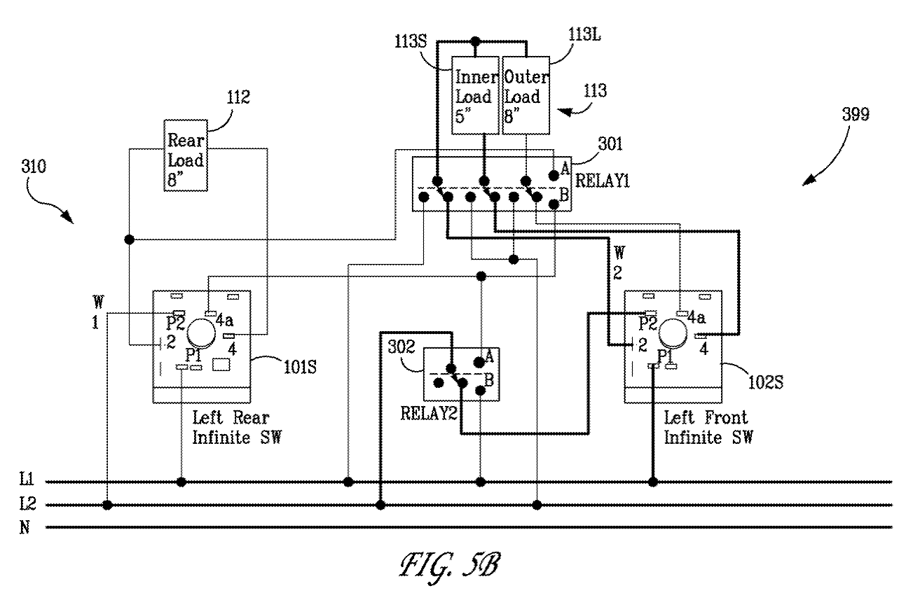

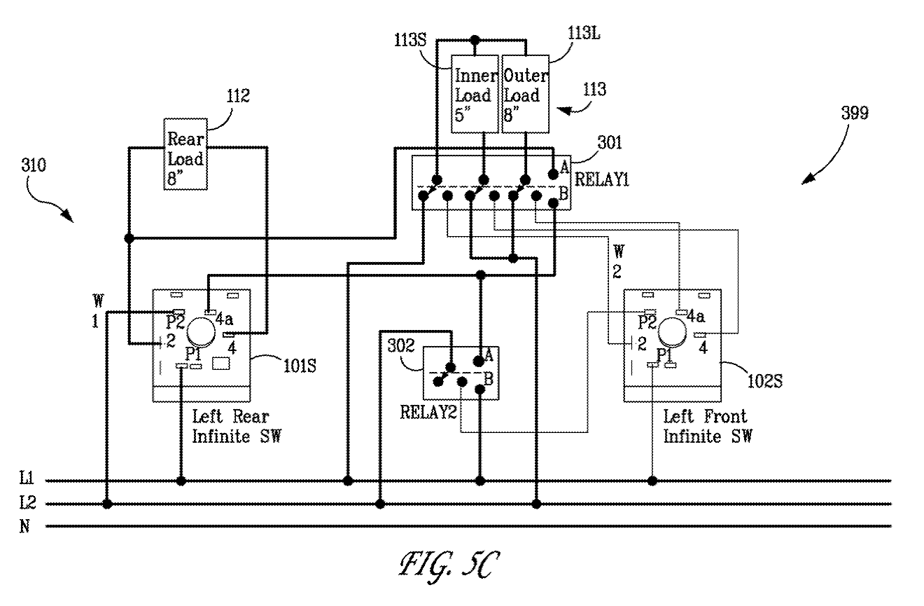

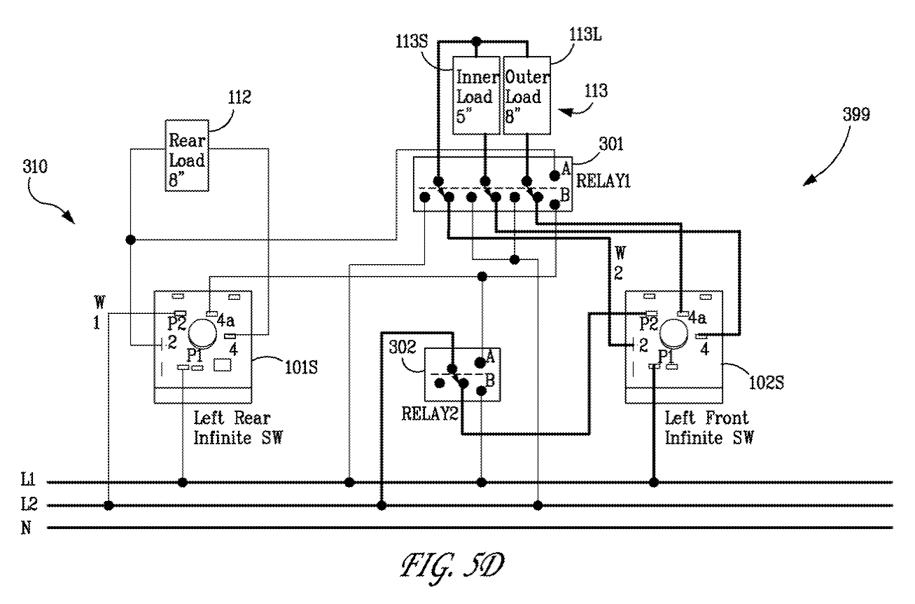

In accordance with the exemplary embodiment, referring also to FIGS. 5A-5D, griddle control, that is operation in the griddle mode, is achieved by a control circuit 310 that includes switch 101S and switch 102S. (In FIGS. 4A-5D, L1 and L2 represent power feeds for supplying power to the switches, relays and heating elements). Circuit 310 is configured to allow independent control of the first and second heating elements 112, 113 through their respective control knobs 101, 102 and switches 101, 102S when the control knob 101 is in an off position or rotated to Side A of switch 101S. Circuit 310 is further configured such that when the griddle mode is activated, the independent control of the first and second heating elements 112, 113 of griddle zone 380 is disabled. The griddle mode is activated by the rotation of control knob 101 to Side B. This rotation to Side B also disconnects or otherwise deactivates other switches corresponding to other heating elements of the griddle zone 380, which in this example is the switch 102S, as is described in more detail below. As a non-limiting example, the griddle mode is enabled by contacts that are engaged by the switch 101S when the control knob 101 (and switch 101S) is rotated to Side B of the switch 101S. Switch 101S includes two sets of contacts where one set of contacts is associated with Side A and both sets of contacts are associated with Side B of the switch. The contacts are configured to control the power transmitted to the respective heating elements by controlling, for example, the duty cycle based on an angle of rotation of the knob 101 of switch 101S which determines the duty cycle of the infinite heat switch in a conventional manner. In this example, the contacts associated with Side A of the switch, when engaged, allow for individual control of heating element 112 in a conventional manner, as is described in more detail below. When the contacts associated with Side B of the switch 101S are engaged through rotation of the control knob 101, the heating element 112 is activated and a first relay 301 and a second relay 302 are activated. The second relay 302, when activated or powered, is configured to deactivate the power to the switch 102S such that the switch 102S is not functional when the griddle mode is enabled (e.g. when switch 101S is turned to Side B). Engaging the contacts associated with Side B of the switch 101S also causes activation of the first relay 301, which is configured to place the heating element 113 (e.g. both elements 113S, 113L of the heating element 113) under the control of the switch 101S. In the exemplary embodiment, first relay 301 is a triple pole, double throw relay. Other suitable relay or other switching device configurations could be similarly employed. By this arrangement, when the griddle mode is active both of the first and second heating elements 112, 113 are controlled only by the second side (Side B) of the switch 101S as a unit.

Circuit Operation Description

Detailed control circuit illustratively implementing the hereinbefore described operating modes and embodying the griddle power control arrangement is represented in simplified schematic form in FIGS. 5A-5D. Power to energize heating elements 110-113 is provided by applying a suitable power signal across terminals for lines L1 and L2. The thick lines indicate “active” connections.

FIG. 5A illustrates the state of the circuit when knob 101 of switch 101S is turned to Side A. Switch 101S includes five contacts, P1, P2, 2, 4 and 4a. P1 is connected internally to contact 2 via an internal bi-metal actuated switch (not shown) which opens a closes with a duty cycle established by the rotary position of switch 101S. Contact P2 is connectable to each of contacts 4 and 4a by internal switches which are open or closed depending on the side switch 101S is turned to. When switch 101S is turned to Side A, P2 is connected to terminal 4 but not 4a. By this arrangement power is supplied to heating element 112 at a duty cycle established by the position of the infinite heat switch 101S. Switch 102S is set to the off position so heating element 113 is not active.

In FIG. 5B, knob 102 of switch 102S is turned to Side A. Switch 102S has the same internal contact arrangement as switch 101S. So with switch 102S turned to Side A, contact P1 is connected to contact 2, and contact P2 is connected to contact 4 but not contact 4a. Power is supplied to inner element 113S at a duty cycle established by the position of the infinite switch 102S through relay 301 which in its normally closed position connects P2 of switch 102S to L2. Outer heating element 113L is inactive because contact 4a is not connected to P2. Switch 101S is set to the off position so heating element 112 is inactive.

In FIG. 5C, switch 101S is turned to Side B which enables the griddle mode. When the switch 101S is turned to Side B, contact P1 of switch 101S is connected to contact 2, and contact P2 is connected to contacts 4 and 4a. When switch 101S is turned to Side B, power is supplied to both the heating elements 112 and 113 under the control of switch 101S. In this mode, heating element 112 is energized as described with respect to FIG. 5A. Heating element 113 is energized under the control of switch 101S as a result of contact P2 being connected to contact 4a. Terminal A of relay 301 is connected to contact 2 of switch 101S and terminal B is connected to contact 4a of switch 101S. By this arrangement, when switch 101S is turned to Side B, the coil of relay 301 is energized at the duty cycle determined by the rotary position of switch 101S just as is heating element 112. When energized, relay 301 closes the normally open contacts as shown in FIG. 5C. When the normally open contacts of relay 301 are closed, heating elements 113S and 113L are connected directly across L1 and L2. So heating elements 113S and 113L are energized when the coil of relay 301 is energized. By this arrangement energization of heating elements 112, 113S and 113L are energized at the duty cycle determined by switch 101S. When contact P2 is connected to contact 4a, the coil of relay 302 is also energized. This switches the relay contacts to the normally open position which disconnects P2 of switch 102S from L2 thereby disabling switch 102S.

In FIG. 5D, switch 101S is in the off position so heating element 112 is not active. Switch 102S is turned to Side B. Contact P1 of switch 102S is connected to contact 2, and contact P2 is connected to contacts 4 and 4a. As shown in FIG. 5D, with the switch 102S turned to Side B, power is supplied to both elements 113S, 113L of heating element 113.

It should be understood that the schematics of the circuit 310 described herein is exemplary in nature and that the circuit may include more or less components than that described.

In accordance with the exemplary embodiment, deactivation of the griddle mode (e.g. rotating control knob 101 to the off position or to Side A of the switch 101S) restores the independent control of the individual heating elements in the griddle zone 380, which in this example are heating elements 112, 113.

Activation of the griddle mode for griddle zone 380, as described herein, may cause activation of corresponding heating elements so that each heating element in the griddle zone 380 produces substantially the same amount of heat as the other heating elements in the griddle zone 380. For example, in this exemplary embodiment, the griddle zone 380 includes both single ring heating elements (e.g., heating element 112) and multiple ring heating elements (e.g., heating element 113). Activation of the griddle mode as described herein may cause activation of the single ring heating elements as well as activation of all the rings (e.g., rings 113S, 113L of dual ring heating element 113) of the multiple ring heating elements where a griddle zone, such as griddle zone 380, comprises a combination of multiple ring and single ring heating elements. The dual ring heating elements 110, 113 in this exemplary embodiment may be configured such that when both the inner and outer rings 113S, 113L are active the surface area of the heat producing elements (and the amount of heat produced) is substantially equal to the surface area (and the amount of heat produced) of the heat producing elements of the single ring heating elements. In alternate embodiments, the amount of power provided to the individual heating elements, such as heating elements 112, 113, may be adjusted so each heating element produces substantially the same amount of heat. Activation of, for example, the single ring and multiple ring heating elements in this manner allows the griddle control to simultaneously control two or more heating elements as a unit such that a substantially uniform heating gradient or output is produced across a cooking surface such as, for example a surface of a griddle 200 (FIG. 2) placed across those heating elements.

The exemplary embodiments described herein provide for easily maintaining a uniform heat output of two or more individually controllable heating elements through a single control. In the exemplary embodiments, when the griddle mode is active the individual control of the two or more heating elements is disabled only to be restored when the griddle control is deactivated.

Thus, while there have been shown and described and pointed out fundamental novel features of the invention as applied to the exemplary embodiments thereof, it will be understood that various omissions and substitutions and changes in the form and details of devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A cooking appliance comprising:
two or more independently controllable heating elements disposed on a cooktop of the cooking appliance; and
a control circuit comprising two or more switches and configured to be
operative in a first mode to enable each switch to independently control a respective one of the two or more independently controllable heating elements, and
operative in a second mode to disable independent control of the two or more independently controllable heating elements, and enable one of the switches to simultaneously control the respective ones of the two or more independently controllable heating elements as a single unit.

2. The cooking appliance of claim 1, wherein the switches comprise infinite heat switches.

3. The cooking appliance of claim 1, wherein the simultaneous control of the respective ones of the two or more independently controllable heating elements as a single unit effects a substantially uniform heat output of the respective ones of the two or more independently controllable heating elements for substantially uniformly heating a cooking surface placed over the respective ones of the two or more independently controllable heating elements.

4. The cooking appliance of claim 1, wherein the control circuit is configured to enable at least one of the two or more switches in a first state to independently control one of the two or more independently controllable heating elements and in a second state to simultaneously control the respective ones of the two or more independently controllable heating elements as a single unit.

5. The cooking appliance of claim 1, wherein the two or more independently controllable heating elements comprise a combination of a single ring heating element and a dual ring heating element, the control circuit being configured to activate the single ring element and both rings of the dual ring heating element.

6. A control system for electric heating elements of a cooking appliance, the control system comprising:
two or more switches configured to independently control respective heating elements disposed in a griddle zone,
wherein the two or more switches are further configured to be operative in a griddle mode to simultaneously control the heating elements disposed in the griddle zone as a single unit.

7. The control of claim 6, wherein the two or more switches comprise infinite heat switches.

8. The control system of claim 6, wherein the simultaneous control of the heating elements disposed in the griddle zone as a single unit effects a substantially uniform heat output of the heating elements for substantially uniformly heating a cooking surface placed over the heating elements.

9. The control system of claim 6, wherein at least one of the two or more switches comprises a dual mode switch, a first mode of the dual mode switch being configured to independently control a respective one of the heating elements and a second mode of the dual mode enabling the griddle mode.

10. The control system of claim 6, wherein the griddle zone includes a combination of a single ring heating element and a dual ring heating element, in the griddle mode, the single ring heating element and both rings of the dual ring heating element being activated.
